(19) United States
(12) Patent Application Publication
(10) Pub. No.: US 2020/0107501 A1
(43) Pub. Date: Apr. 9, 2020

(54) FARM TRACTOR APPARATUS FOR PICKING UP GROUND FALLEN FRUITS

(71) Applicant: Eric Maisonneuve, St-Amable (CA)

(72) Inventor: Eric Maisonneuve, St-Amable (CA)

(21) Appl. No.: 16/583,210

(22) Filed: Sep. 25, 2019

(30) Foreign Application Priority Data
Oct. 6, 2018 (GB) 1816330.3

(51) Int. Cl. A01D 51/00

(52) U.S. Cl. CPC A01D 51/00

(57) ABSTRACT

The invention comprises a first and a second spiral sweeper. The first sweeper is laid down diagonally in front of the tractor and sweeps fruits away from the front of the tractor and directs them towards a second spiral sweeper also arranged diagonally so that both spiral sweepers form a “V” pattern which drives the fruits towards a low riding section of a conveyor belt which extends onto a rising section, which then drops the fruits into a bin. The apparatus is attached to a standard three-pint hitch at the rear of the tractor which provides the hydraulic power to drive the brushes and pistons, while a power take-off provides power for the conveyor and an optional blower. The apparatus is also attached by way of an attachment bracket to the front of the tractor.

### CROSS-REFERENCE TO RELATED APPLICATIONS

The present application claims priority to United Kingdom Patent Application serial number GB1816330.3, filed on Oct. 6, 2018, the disclosure of which is hereby incorporated in its entirety at least by reference.

### BACKGROUND OF THE INVENTION

### 1. Field of the Invention

The present invention generally relates to farm tractor accessories but more particularly to a farm tractor apparatus for picking up ground fallen fruits.

### 2. Description of Related Art

In general practice, government regulations in many jurisdictions require that fruits for human consumption be picked directly from the tree rather than off the ground. Unfortunately, before and during harvest time, a lot of fruits fall on the ground. Most of those are salvaged for use in making fruit juice and some for sale to hunters who buy the fruits in large bags for use as bait when hunting. Because fallen fruits represent a potentially lucrative secondary market, there is an incentive to utilize these fallen fruits, as long as there is a quick and economical way of doing it. Current mechanized systems are less than ideal because they fail to collect enough fruits and in fact, are more prone to damage the fruits than pick them. Consequently, there needs to be a farm tractor apparatus offing an efficient, practical, and economical way for collecting fruits on the ground.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In one aspect of the invention, a farm tractor apparatus configured to be attached to be a farm tractor for picking up fruits off the ground, the farm tractor apparatus comprising a first spiral sweeper positioned diagonally in front of the farm tractor; a second spiral sweeper positioned diagonally relative to a side portion of the tractor; a conveyer belt; and, wherein the first spiral sweeper is configured to direct the fruits away from the front of the farm tractor towards the second spiral sweeper which directs the fruits towards the conveyer belt to be collected.

In one embodiment, the conveyer belt includes a low riding conveyor section. In one embodiment, the first spiral sweeper and the second spiral sweeper creates a “V” pattern which funnels the fruits towards the low riding conveyor section. In one embodiment, the first spiral sweeper includes a first brush and the second spiral sweeper includes a second brush and a third brush. In one embodiment, the first, second, and third brush each includes spiral bristles. In one embodiment, the diagonal position of each of the first spiral sweeper and the second spiral sweeper are variable and controlled by a first hydraulic piston and a second hydraulic piston respectively. In another embodiment, the second hydraulic piston is coupled to a pressure detector configured to inform an operator that the second spiral sweeper is overloaded and that a sharper angle of the diagonal position is required. In one embodiment, the second hydraulic sweeper is supported by a set of support wheels attached to a wheel bracket, wherein the wheel bracket connects to a frame configured to support the second hydraulic sweeper.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a top view of a farm tractor apparatus according to an embodiment of the present invention;

FIG. 2 is a front view of the a farm tractor apparatus according to an embodiment of the present invention;

FIG. 3 is a top view of a sweeper of the farm tractor apparatus according to an embodiment of the present invention; and,

FIG. 4 is a side view of a conveyor system of the farm tractor apparatus according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a farm tractor apparatus for picking up ground fallen fruits.

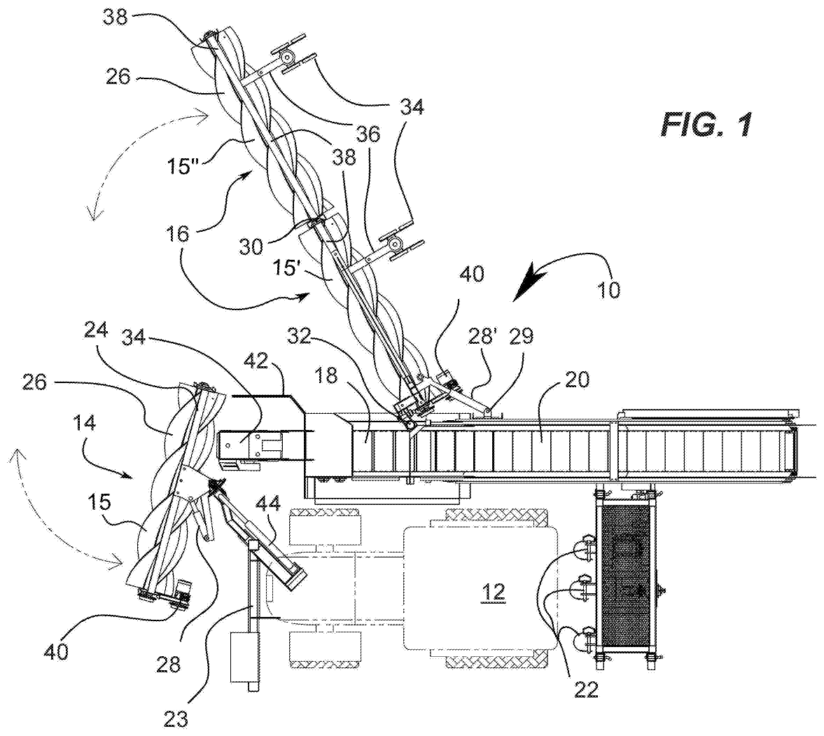

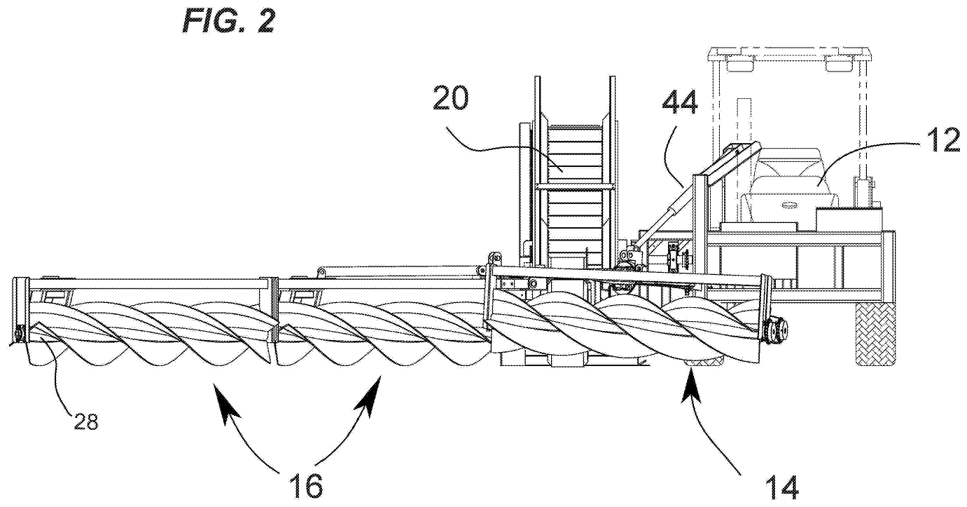

Referring now to any of the accompanying FIGS. 1-4, the farm tractor apparatus 10 installed on tractor 12 is illustrated. Advantageously, the farm tractor apparatus is configured to pick up fruit that has fallen on the ground and is no longer fit for sale in produce departments designated for human consumption. In one embodiment, the farm tractor apparatus 10 is attached to a rear portion of the tractor 12 to a standard three-point hitch via attachment bracket 22 providing the hydraulic power to drive the farm tractor apparatus 10.

In one embodiment, the apparatus comprises a first spiral sweeper 14, a second spiral sweeper 16, and conveyer 20. The first and second sweepers are configured to optimally direct fruit to the conveyer in efficient manner that protects the fruit from damage. More specifically, the first spiral sweeper 14 sweeps fruits away from the front portion of the tractor 12, preventing the fruit from damage via the tractor, and then directs the fruit towards the second spiral sweeper 16, which directs the fruit to the conveyer 20. This will be discussed in further detail below.

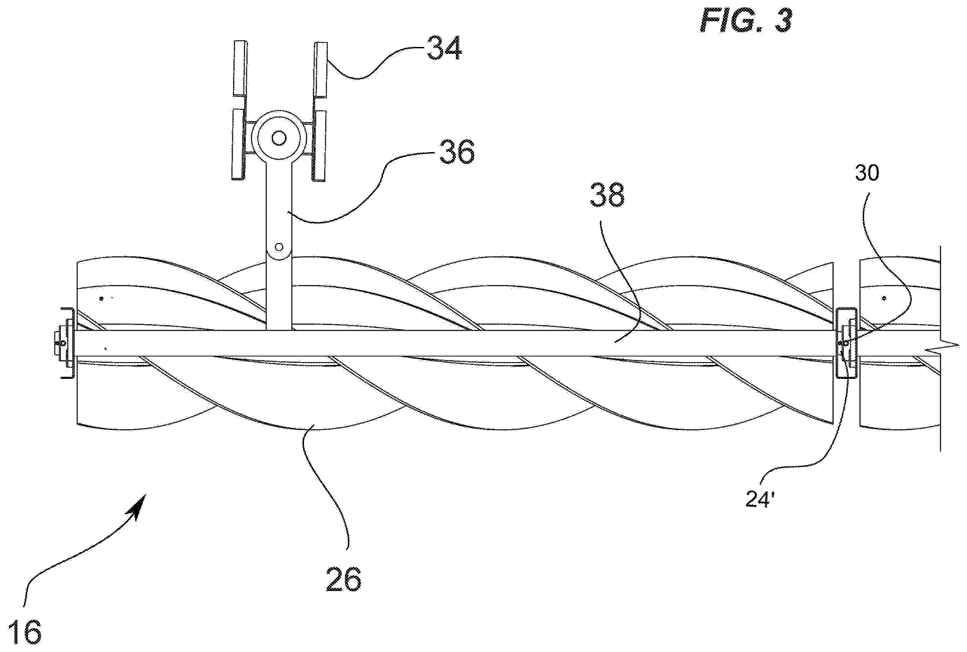

In one embodiment, the first spiral sweeper 14 is positioned diagonally in the front of the tractor 12 via a first bracket 23. In one embodiment, a support hydraulic piston 44 is configured to support the first spiral sweeper 14. In some embodiments, the first spiral sweeper 14 includes one brush 15 having spiral bristles 26. The diagonal position or angle of the first spiral sweeper is variably controlled via hydraulic piston 28. Similarly, the second spiral sweeper 16 is positioned diagonally on the side of the tractor 12 and is variably controlled via hydraulic piston 28′. Best seen in FIG. 3, support wheels 34 connect to wheel bracket 36 which connects to frame 38 supporting the second spiral sweeper 16. In one embodiment, the second spiral sweeper 16 is comprised of two brushes a proximal brush 15′ and a distal brush 15″, wherein the proximal brush 15 ‘and the distal brush 15″ extend radially from shaft 24’. Similarly, brush 15 on the first spiral sweeper 14 extends radially from shaft 24. In one embodiment, a shear pin 30 is installed between the proximal brush 15′ and the distal brush 15″ to prevent damage from the equipment. More specifically, the shear pin protects the distal brush 15″ in the event an obstacle on the ground creates undo resistance which would damage the second spiral sweeper 16.

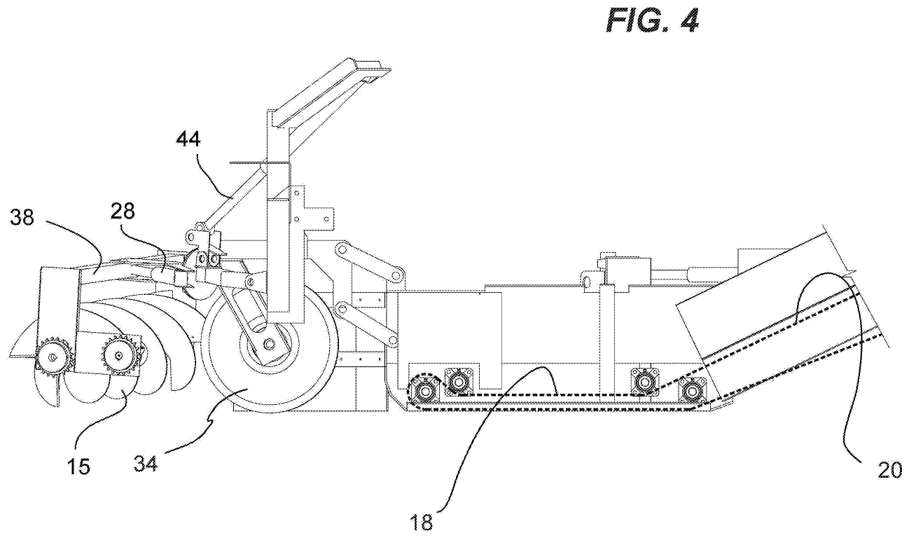

Advantageously, the arrangement of the first spiral sweeper 14 and the second spiral sweeper 16 creates a “V” pattern configured to funnel the ground fallen fruits towards the conveyer 20 via a low riding conveyor section 18 (best seen in FIG. 4). The low riding conveyor section is approximate to the ground surface. As the fruits are transferred to through the conveyer system, i.e. the low riding conveyor section 18 to conveyer 20, the fruits eventually fall into a bin (not shown) from the top of the conveyor belt. In some embodiments, the bin is installed on a wheeled cart (not shown) hitchedly attached to the rear of the farm tractor apparatus 10. In one embodiment, a guard plate 42 prevents the collected fruits from straying off the path towards the conveyor belt 20 during operation.

In one embodiment, the angle adjustment of the second spiral sweeper 16 is provided by the hydraulic piston 28′. The hydraulic piston 28′ is coupled to a pressure detector 29 which informs the operator that the second spiral sweeper 16 is overloaded and that a sharper angle is required. Occasionally, this may happen when there are a lot of fruits on the ground. In some embodiments, a blower (not shown) may be used to remove twigs, leaves, and other debris enabling the collection of mostly fruits without also collecting the debris. Further, the sweeping action of the first spiral sweeper and the second spiral sweeper 16 allows for some twigs and leaves to be blown off, which reduces their quantity in the bin, but preferably, a blower is used for that purpose as previously discussed.

As previously mentioned, the angles of the first and second spiral sweeper are variable. The first spiral sweeper 14 is hydraulically adjustable from 0 to over 45 degrees in relation to the front portion of the tractor. Likewise, the angle of the second spiral sweeper 16 is manually adjustable to a similar angle range based on data provided by the pressure detector 29. The variation of the angles allow the over width of the farm tractor apparatus to vary, such that it can be made wider or narrower simply by varying the angle of the second spiral sweeper. This is useful for enabling the tractor with the attached apparatus to pass between trees.

In some embodiments, there is one hydraulic motor 40 for the first and the second spiral sweeper while the conveyor belt 20 is powered by way of the power take-off from the tractor. Typically, all brushes 15, 15′, and 15″ have the same length, however as previously mentioned the second spiral sweeper 16 includes the combination of two brushes 15′ and 15″. In some embodiments, the brushes are made of a semi rigid material, such as plastic or rubber, chosen for its ability to move fruits with minimal damage. In some embodiments, the spiral shape of the brushes is optimized in an arc which is preferably of three degrees per inch, which gives it the shape of a long curve. The rotation speed of the first and second spiral sweepers combined with the forward motion of the tractor and the long curved shape all combine to provide the necessary mechanical action to drive the fruits towards the low riding conveyor section 18 with minimal damage to the fruits.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A farm tractor apparatus configured to be attached to be a farm tractor for picking up fruits off the ground, the farm tractor apparatus comprising:
a first spiral sweeper positioned diagonally in front of the farm tractor;
a second spiral sweeper positioned diagonally relative to a side portion of the tractor;
a conveyer belt; and,
wherein the first spiral sweeper is configured to direct the fruits away from the front of the farm tractor towards the second spiral sweeper which directs the fruits towards the conveyer belt to be collected.

2. The farm tractor apparatus of claim 1, wherein the conveyer belt includes a low riding conveyor section.

3. The farm tractor apparatus of claim 2, wherein the first spiral sweeper and the second spiral sweeper creates a “V” pattern which funnels the fruits towards the low riding conveyor section.

4. The farm tractor apparatus of claim 1, wherein the first spiral sweeper includes a first brush and the second spiral sweeper includes a second brush and a third brush.

5. The farm tractor apparatus of claim 4, wherein the first, second, and third brush each includes spiral bristles.

6. The farm tractor apparatus of claim 1, wherein the diagonal position of each of the first spiral sweeper and the second spiral sweeper are variable and controlled by a first hydraulic piston and a second hydraulic piston respectively.

7. The farm tractor apparatus of claim 6, wherein the second hydraulic piston is coupled to a pressure detector configured to inform an operator that the second spiral sweeper is overloaded and that a sharper angle of the diagonal position is required.

8. The farm tractor apparatus of claim 1, wherein the second hydraulic sweeper is supported by a set of support wheels attached to a wheel bracket, wherein the wheel bracket connects to a frame configured to support the second hydraulic sweeper.
